(19) United States
(12) Patent Application Publication
(10) Pub. No.: US 2021/0034225 A1
(43) Pub. Date: Feb. 4, 2021

(54) TEMPLATES FOR RAPID DEVELOPMENT OF NATIVE MOBILE APPLICATION GRAPHICAL USER INTERFACES

(71) Applicant: ServiceNow, Inc., Santa Clara, CA (US)

(72) Inventors: Nir Harazi, Ramat Gan (IL); Avi Sasson, Givatayim (IL); Maor Cohen, Jerusalem (IL)

(21) Appl. No.: 16/528,241

(22) Filed: Jul. 31, 2019

(51) Int. Cl. G06F 3/0484; G06F 3/0482; H04L 12/24

(52) U.S. Cl. CPC G06F 3/04847; G06F 3/0482; G06F 3/04817; G06F 3/04845; H04L 41/22

(57) ABSTRACT

A computational instance of a remote network management platform may include: persistent storage, containing definitions of a plurality of graphical user interface (GUI) element templates, and one or more computing devices configured to: (i) transmit a first GUI that provides the plurality of GUI element templates; (ii) receive a selection of a GUI element template represented as a pre-defined hierarchy of one or more GUI elements; (iii) transmit a second GUI that allows visual configuration of a native mobile application that uses the GUI element template, where the GUI elements are horizontal containers, vertical containers, image boxes, or text boxes, are organized according to the pre-defined hierarchy, and are populated with default values; (iv) receive an update to the visual configuration including changes to one or more of the default values; and (v) store, in the persistent storage and using a structured data format, the visual configuration as updated.

### BACKGROUND

Native mobile applications are programs specifically designed to execute on the operating system of a mobile device, such as a mobile phone, tablet, smartwatch, or any other type of wireless communication device. Such native mobile applications may be pre-packaged with the device or downloaded to the device at a later time. These applications may allow access to data of a web site or server, and may present this data in a customized fashion on a graphical user interface. This, and the ability for native mobile applications to request specific subsets of the data that is to be presented, results in these applications having numerous advantages over accessing the same data by way of a web browser.

### SUMMARY

In the enterprise context, native mobile applications can be advantageously deployed so that employees can access enterprise-related data and services from their mobile devices, regardless of whether they are located on enterprise premises or elsewhere. As a consequence, enterprises may wish to develop and deploy native mobile applications customized for various uses within the enterprise. The enterprise-related data may be disposed within a remote network management platform that manages the enterprise's network, within the enterprise's managed network, within a remotely-hosted network (e.g., a public cloud service) used by the enterprise, or elsewhere.

But development and maintenance of a custom native mobile application can be a challenging task and require a specific set of skills on the part of the developers. Further, once such a native mobile application is deployed, updates must either be pushed or manually downloaded to each mobile device. As a result, even minor changes to the native mobile application may not be able to be widely deployed for days or weeks.

The embodiments herein provide a flexible approach for rapid development and modification of native mobile applications. In particular, the graphical user interface (GUI) layout and content of a native mobile application is data driven—for example configured in a JavaScript Object Notation (JSON) string or file, an eXtensible Markup Language (XML) string or file, or in some other structured data format as a set of containers, images, and text elements.

Further, a native mobile application may also support numerous default arrangements by way of GUI layout templates. Thus, rather than manually coding the content and/or layout of the native mobile application in a high-level programming language (e.g., such as JAVA®), an enterprise administrator can use one or more of the templates to define the GUI layout and content of the native mobile application.

The embodiments herein provide a web-based GUI for the administrator to do so, which facilitates rapid deployment and updating of the native mobile application (in some cases, GUIs that are not web-based may be used). From the web-based GUI, the administrator can drag and drop content and layout widgets representing the containers, images, and text elements onto a canvas that emulates the look and feel of the native mobile application. Once the administrator is satisfied with this arrangement, he or she may cause the web-based GUI to create a structured data file specifying the GUI layout and content of the native mobile application in a hierarchical or tree-like organization. This file can be automatically deployed to mobile devices throughout the enterprise, e.g., the next time the mobile devices request content. The native mobile application then displays the GUI layout and content as specified in the file.

Accordingly, a first example embodiment may involve a computational instance of a remote network management platform including persistent storage containing definitions of a plurality of GUI element templates, each defined in a structured data format, and one or more computing devices configured to: (i) transmit, to a client device, a first GUI, where the first GUI provides the plurality of GUI element templates; (ii) receive, from the client device, a selection of a GUI element template from the plurality of GUI element templates, where the GUI element template is represented as a pre-defined hierarchy of one or more GUI elements; (iii) possibly in response to receiving the selection of the GUI element template, transmit, to the client device, a second GUI that allows visual configuration of a native mobile application that uses the GUI element template, where the one or more GUI elements within the GUI element template are horizontal containers, vertical containers, image boxes, or text boxes, are initially organized according to the pre-defined hierarchy, and are respectively populated with default values; (iv) receive, from the client device, an update to the visual configuration of the native mobile application including changes to one or more of the default values of the GUI elements of the GUI element template; and (v) store, in the persistent storage and using the structured data format, a representation of the visual configuration of the native mobile application as updated.

A second example embodiment may involve transmitting, by a server device and to a client device, a first GUI, where the first GUI provides a plurality of GUI element templates, each defined in a structured data format. The second example embodiment may also involve receiving, by the server device and from the client device, a selection of a GUI element template from the plurality of GUI element templates, where the GUI element template is represented as a pre-defined hierarchy of one or more GUI elements. The second example embodiment may also involve, possibly in response to receiving the selection of the GUI element template, transmitting, by the server device and to the client device, a second GUI that allows visual configuration of a native mobile application that uses the GUI element template, where the one or more GUI elements within the GUI element template are horizontal containers, vertical containers, image boxes, or text boxes, are initially organized according to the pre-defined hierarchy, and are respectively populated with default values. The second example embodiment may also involve receiving, by the server device and from the client device, an update to the visual configuration of the native mobile application including changes to one or more of the default values of the GUI elements of the GUI element template. The second example embodiment may also involve storing, by the server device and in persistent storage, a representation of the visual configuration of the native mobile application as updated, where the representation is in the structured data format.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A is a message flow diagram, in accordance with example embodiments.

FIG. 6B is a message flow diagram, in accordance with example embodiments.

FIG. 7A is a structured data format encoding a hierarchical GUI, in accordance with example embodiments.

FIG. 7B depicts a hierarchy of GUI elements, in accordance with example embodiments.

FIG. 7C depicts hierarchical GUI, in accordance with example embodiments.

FIG. 7D depicts a class hierarchy for implementing GUI elements, in accordance with example embodiments.

FIG. 8A depicts a hierarchically-defined native mobile application GUI, in accordance with example embodiments.

FIG. 8B depicts GUI elements of a hierarchically-defined native mobile application GUI, in accordance with example embodiments.

FIG. 9 depicts a web-based GUI for selecting a GUI element template, in accordance with example embodiments.

FIGS. 10A, 10B, 10C, 10D, and 10E depict a web-based GUI for arranging and configuring GUI elements, in accordance with example embodiments.

FIG. 10F depicts a hierarchically-defined native mobile application GUI, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

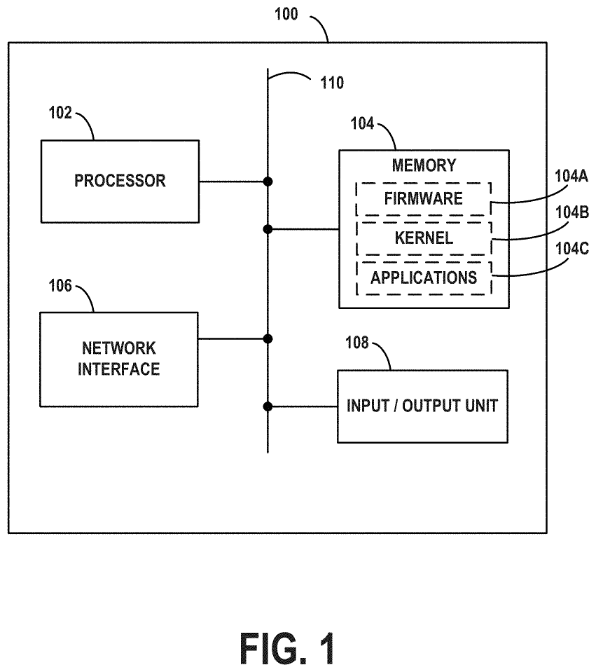

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

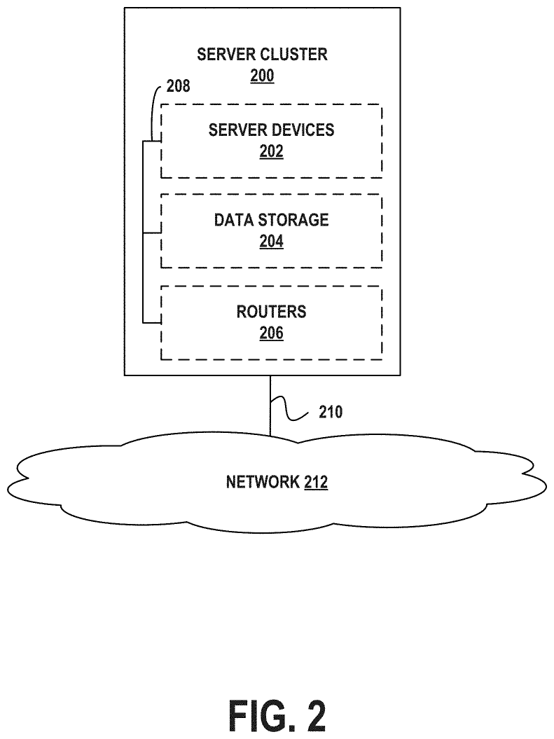

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages.

### III. EXAMPLE REMOTE NETWORK MANAGEMENT ARCHITECTURE

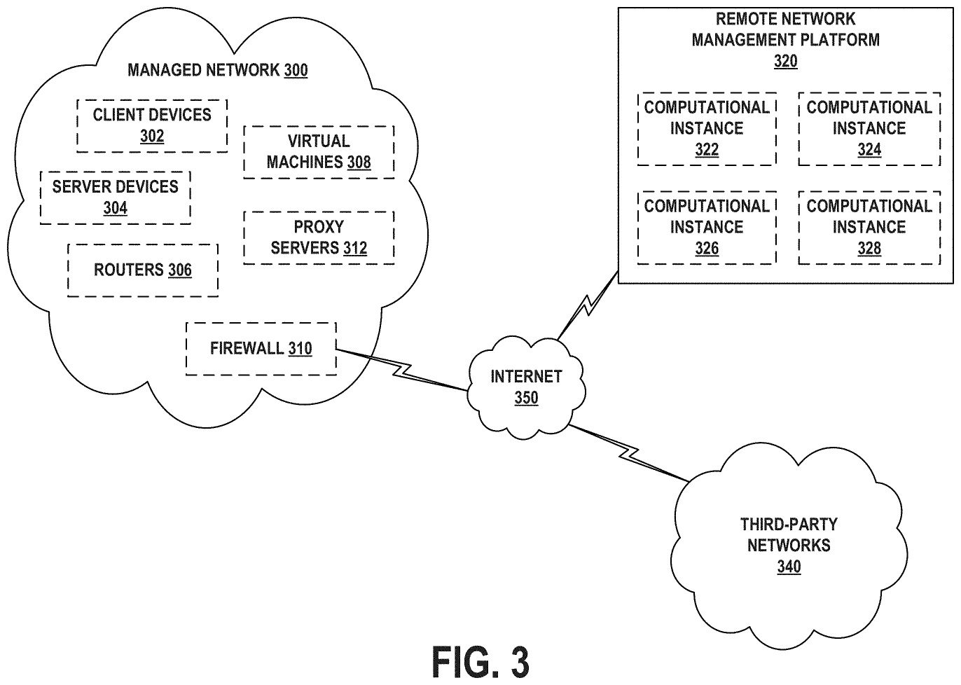

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent one or more server devices and/or one or more databases that provide a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows with one or more database tables).

For purpose of clarity, the disclosure herein refers to the physical hardware, software, and arrangement thereof as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are commingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents commingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of physical or virtual servers and database devices. Such a central instance may serve as a repository for data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® AZURE®. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

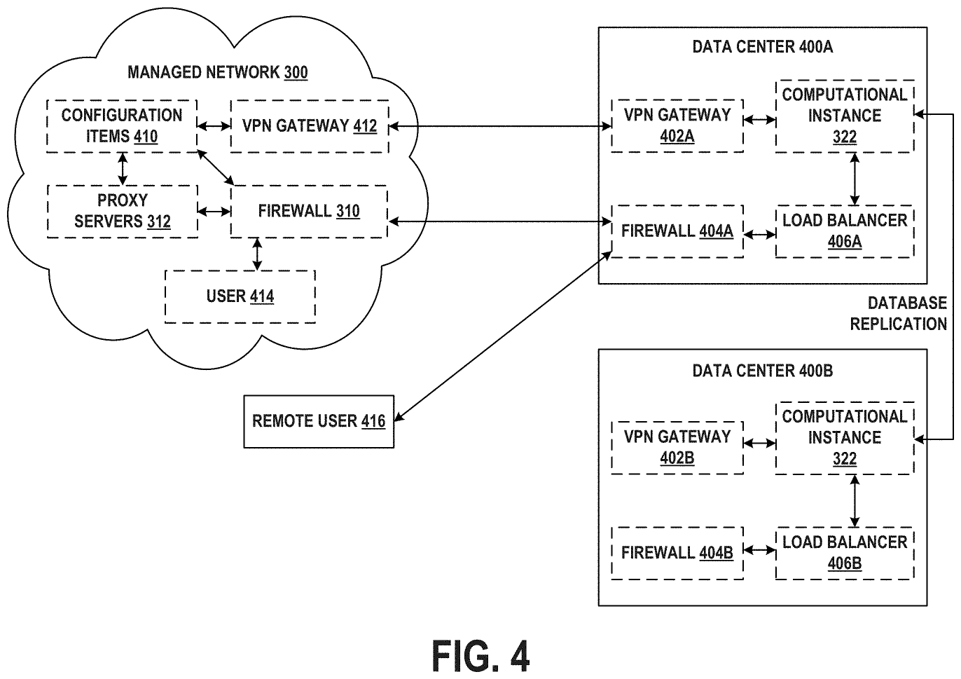

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

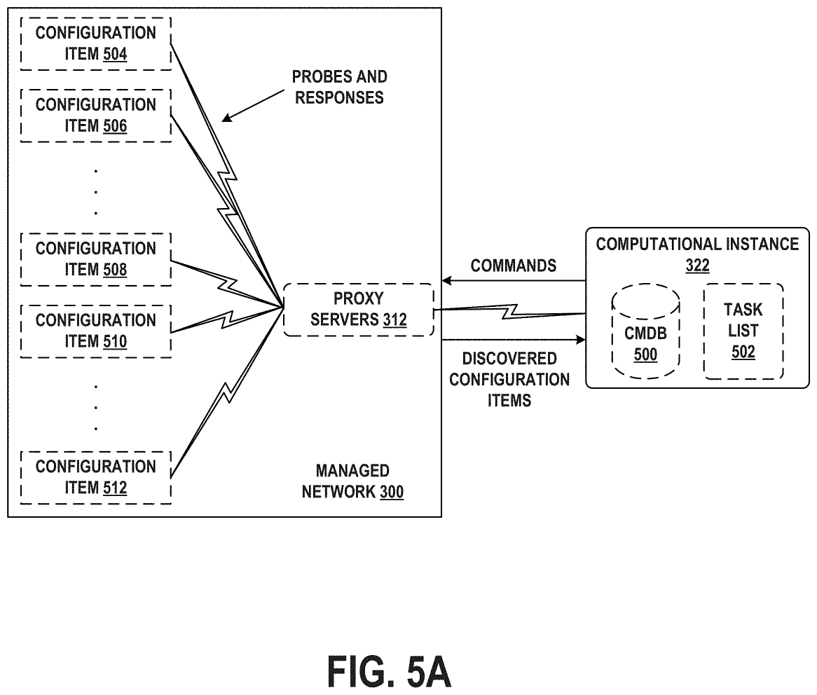

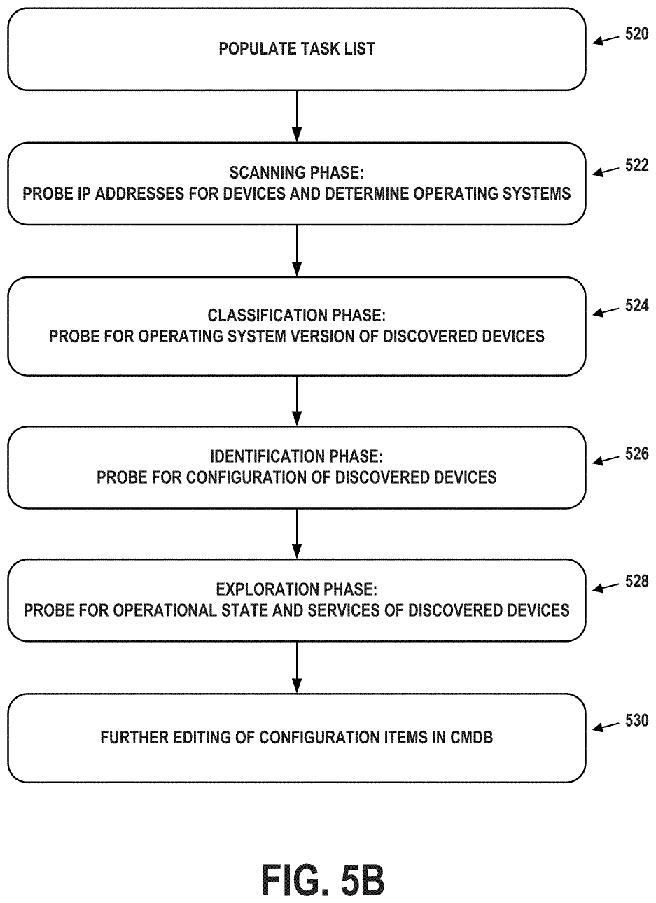

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. EXAMPLE NATIVE MOBILE APPLICATIONS

For purposes of the embodiments discussed herein, a “mobile device” may be any type of computing device that accesses a network by way of a wireless interface. Nonetheless, other types of devices may use and benefit from these embodiments.

The use of mobile devices, such as smartphones, smartwatches, tablets, and so on has become ubiquitous. As such, users of a remote network management platform may expect to be able to obtain access thereto from such mobile devices around the clock and from a variety of physical locations. However, at least three issues exist.

First, the relatively small screen size of a mobile device limits the amount of information that can be displayed at any one point in time on the device. For instance, a typical smartphone may have a diagonal screen size of 6-7 inches, whereas a desktop computer may be attached to a monitor with a 30 inch (or more) diagonal screen size. Thus, the amount and type of data displayed at any one point in time may be severely limited on mobile devices as opposed to desktop (or even laptop) computers. Notably, web pages provided by the remote network management platform may display appropriately on a large screen, but might be shrunk to a nearly unreadable size on the screen of a mobile device.

Second, there are many configurations and screen sizes for mobile devices, and an application may render and scale differently across different devices. These differences can be between different mobile devices from the same manufacturer (e.g., a tablet versus a smartphone) or comparable wireless devices from different manufacturers (e.g., two similarly sized smartphones with different button placements). This result is often problematic because it can lead to inconsistent user experiences with an application used across such mobile devices. This problem is increased by the fact that many of these mobile devices also use different versions of a particular operating system or platform, or different operating systems or platforms, altogether. Users of these applications who experience these problems between different mobile devices may be left with inconsistent (potentially frustrating) impressions.

Third, users often interact with certain kinds of mobile devices differently than they would with other devices. For example, a user interacting with a smartphone, smartwatch, tablet, and the like is more inclined to view and interact with the device from multiple angles, often rotating the orientation of the device to suit the user's preference, than with other, more stationary devices (e.g., a television, desktop computer, etc.). However, even when rotating the device, the user may expect to see a seamless continuity of content and the arrangement of that content regardless of the orientation of the device. As discussed above, this expectation may be problematic because it can lead to inconsistent user experiences with an application used across such mobile devices because the application might not only render and scale differently across different devices, but also across different orientations of the same device (e.g., in a portrait versus landscape orientation modes). Without this continuity of experience while rotating the device, the user may become frustrated and underutilize the device (e.g., only view content in a portrait mode, even if it is better suited for horizontal viewing), or may stop viewing content on the device altogether.

The embodiments herein help to address these problems by providing ways to define and configure a native mobile application executing on a mobile device. The native mobile application is compiled or interpreted directly by the mobile device by way of the mobile device's operating system and/or supporting libraries. Unlike a generic web browser or applications that download for execution in a web browser, the native mobile application is designed specifically for communicating with a computational instance of a remote network management platform or another source of data.

By way of this communication, a server device (e.g., of a computational instance) may provide content for display pursuant to a particular arrangement on the mobile device based on instructions that are largely device, platform, and orientation independent. These instructions may arrange and scale the content on the mobile device accordingly (e.g., via a set of instructions detailing a recursively-defined, container-based arrangement of content, regardless of the device). Thus, content and/or its arrangement can be designed to be easily readable even with the limited screen size of the mobile device, no matter what device the content is displayed on, the operating system and/or platform running on that device, or the orientation of that device from the user's perspective.

Furthermore, the native mobile application may be able to determine when the content on the mobile device is modified and responsively take further action. For instance, the native mobile application may detect when a user has modified the content on the mobile device via a displayed GUI. In some cases, the mobile device may determine that it should request further content and instructions for arranging that content in accordance with GUI layout instructions using the native mobile application (e.g., in one or more previously defined containers, rows, etc.).

Along with the content and/or arrangement provided to the mobile device, the native mobile application may update its GUI to reflect changes (e.g., due to navigation to changing values of displayed data) made by a user based on a number of factors. For example, when a user rotates the device (e.g., from portrait to landscape) the native mobile application may respond by maintaining the attributes and proportions of the previously displayed screen, just in a different orientation. Alternatively, the native mobile application may automatically scale the previously-displayed content in a more appropriate or pleasing view based on the rotated orientation (e.g., automatically scale the content that was displayed in portrait view to fit and fill a landscape view). In this way, when the native mobile application determines that the mobile device has changed physical orientation between landscape and portrait orientation modes, it can generate an updated GUI that represents the content spatially organized according to a particular arrangement. Further, because the screen of the mobile device may have different relative dimensions in the landscape and portrait orientation modes, the updated GUI may also contain less or more of the content than the GUI prior to updating.

Additionally, the native mobile application may request, from one or more server devices, further content and arrangement for displaying that updated content based on a set of previously-used and/or previously-defined interactions with the server devices. For example, based on previously displaying content in accordance with an arrangement (e.g., a recursively-defined, container-based arrangement of content), the native mobile application may generate a request for additional content that the mobile device does not have stored locally (e.g., images, text, or both), receive the updated content, and display that content based on instructions that display the updated content similarly to the previous instructions. The result can be a dramatically improved user experience that allows for seamless, adaptive scaling across multiple devices, platforms, and device orientations, all without crowding the local memory and storage of the mobile device.

In addition to these advantages, the GUI layout and content of the native mobile application can easily be modified. Developing native mobile applications for mobile devices requires a high level of skill, and these applications may need to be updated from time to time. The embodiments herein provide intuitive web-based GUIs through which even a non-technical user can visually define the GUI layout and content of the native mobile application as a hierarchy of containers, images, and text. Thus, the native mobile application can be rapidly adapted to changing enterprise needs without having to rewrite the source code of, re-compile, and/or re-deploy the native mobile application.

A. Obtaining Displayable Content

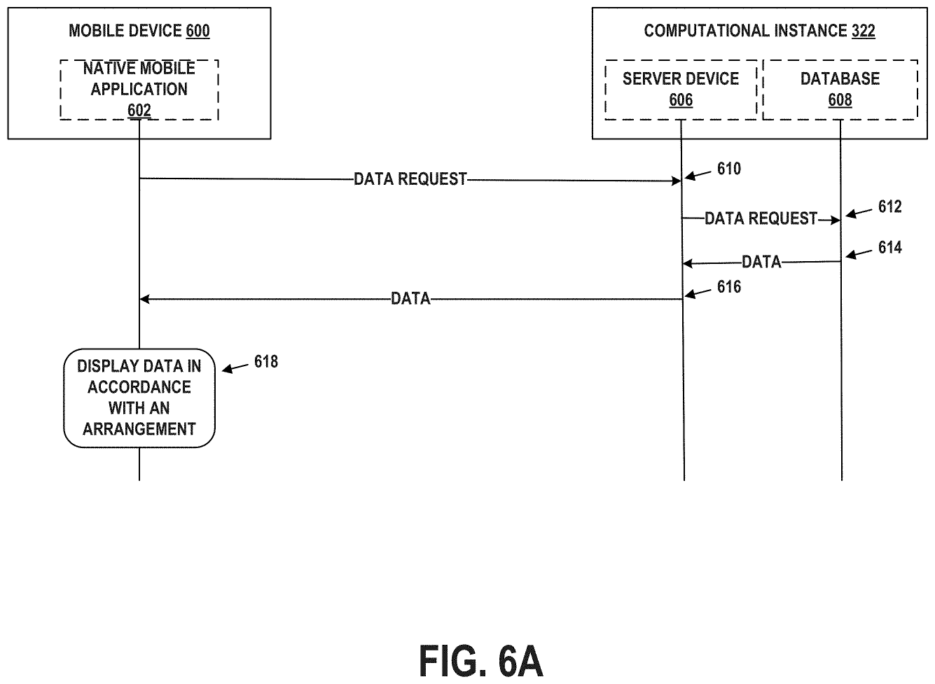

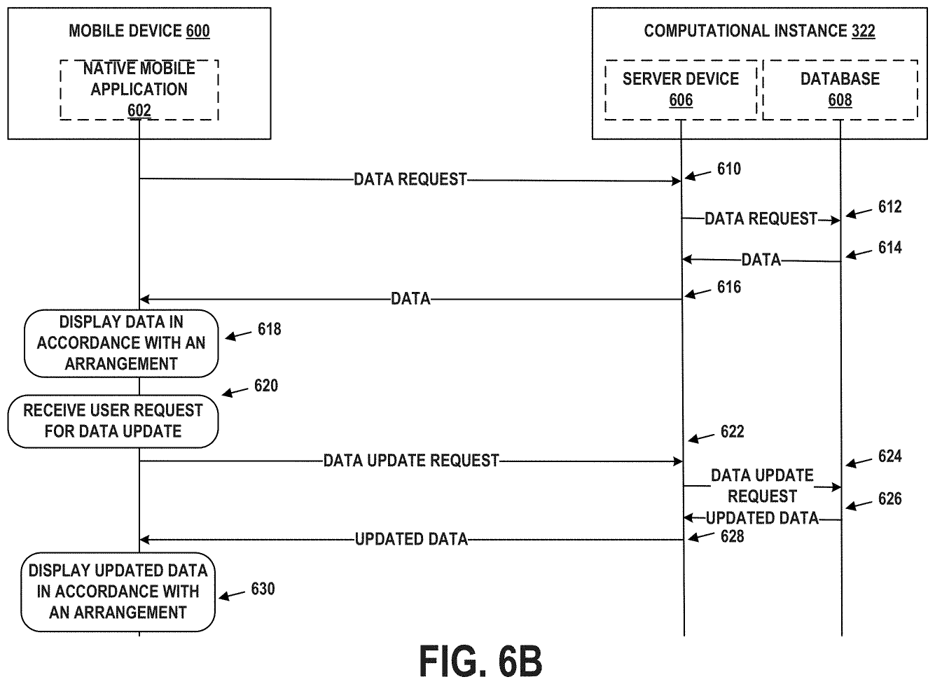

For sake of comparison, FIG. 6A depicts a transaction between a native mobile application and a server device when a mobile device is executing the native mobile application and displaying content pursuant to a particular arrangement, and then FIG. 6B depicts a similar transaction but including updating that content in light of a user's interaction with and modification of the displayed content.

In FIG. 6A, mobile device 600 may include a processor, memory, one or more communication interfaces, a screen capable of displaying a GUI (e.g., a touchscreen), and so on. Mobile device 600 may also contain, among other software modules, native mobile application 602.

Mobile device 600 may be configured to communicate with server device 606, which may be part of computational instance 322, for example. Server device 606 may, in turn, access database 608 to obtain information to transmit to mobile device 600, as well as to store information received from mobile device 600. In alternative embodiments, server device 606 and database 608 may be disposed within managed network 300 or third-party networks 340.

At step 610, native mobile application 602 may transmit a data request to server device 606. The data request may be for data to display on a GUI of native mobile application 602, and may be transmitted in response to user activity and/or based on other criteria.

At steps 612 and 614, server device 606 may request and receive the requested data from database 608. In some embodiments, server device 606 may omit these steps if it contains a copy of the requested data.

At step 616, server device 606 may transmit the requested data to native mobile application 602. This data may include content for display on the GUI as well as define a particular arrangement of this content, and instructions for displaying the content pursuant to the particular, defined arrangement (e.g., a recursively-defined, container-based arrangement of content).

At step 618, in response to receiving the data, native mobile application 602 may display the content on the GUI in accordance with the arrangement. As an example, native mobile application 602 may display the content as a vertical or horizontal list of elements providing parameters and associated values, all mapped pursuant to a recursively-defined, container-based arrangement of content.

FIG. 6B depicts a transaction similar to that of FIG. 6, but also shows updating that content in light of a user's interaction with and modification of the content. At step 610, native mobile application 602 may similarly transmit a data request to server device 606. At steps 612 and 614, server device 606 may request and receive the requested data from database 608. At step 616, server device 606 may transmit the requested data to native mobile application 602, and the requested data may include content for display on the GUI as well as a particular, defined arrangement of this content (e.g., a recursively-defined, container-based arrangement of content).

At step 618, in response to receiving the data, native mobile application 602 may similarly display the content on the GUI in accordance with the arrangement. For example, the content may be displayed as a vertical list of rows providing parameters, and associated values, all mapped pursuant to a recursively-defined, container-based arrangement of content (e.g., utilizing the one or more identifiers within one or more of the recursively-defined containers).

At step 620 (which may take place before, after, or in response to reception of the data of step 618), after the content is displayed, native mobile application 602 may receive a user request to update the data. For instance, the user may change the value of one of the displayed content parameters (e.g., selecting a menu option or a particular value to edit).

Thus, at step 622, native mobile application 602 may transmit, to server device 606, a data update request with the parameter as changed. At steps 624 and 626, server device 606 may transmit the updated data to database 608 and receive an acknowledgement that the data has been updated or a copy of the updated data.

At step 628, server device 606 may transmit, to native mobile application 602, a copy of the updated data. This copy may also include any updates made to the overall content and layout of the GUI due to the change in content. For example, if the data as updated takes up more vertical space to display in the GUI, the updated GUI may omit other information that was previously displayed in order to fit the parameter. In another example, the updates might not change anything about the overall layout of the GUI, but may just replace the content that is displayed therein (e.g. text, images, both). Thus, if content is displayed pursuant to a certain set of layout parameters (e.g., a vertical list of rows incorporating a recursively-defined, container-based arrangement of content), as the content is updated, the server device may not have to send updated layout parameters. Instead, the server device may just send content updates containing data that goes in those defined layout parameters. Additionally, at step 630, native mobile application 602 may refresh its GUI to reflect any such updates.

Furthermore, in this fashion, database 608 is updated based on the most recent input from the user of mobile device 600. In this way, the data displayed on the GUI of native mobile application 602 and stored in database 608 may be synchronized and updated instead of requiring duplicative processing and storage.

B. Example Content Encoding

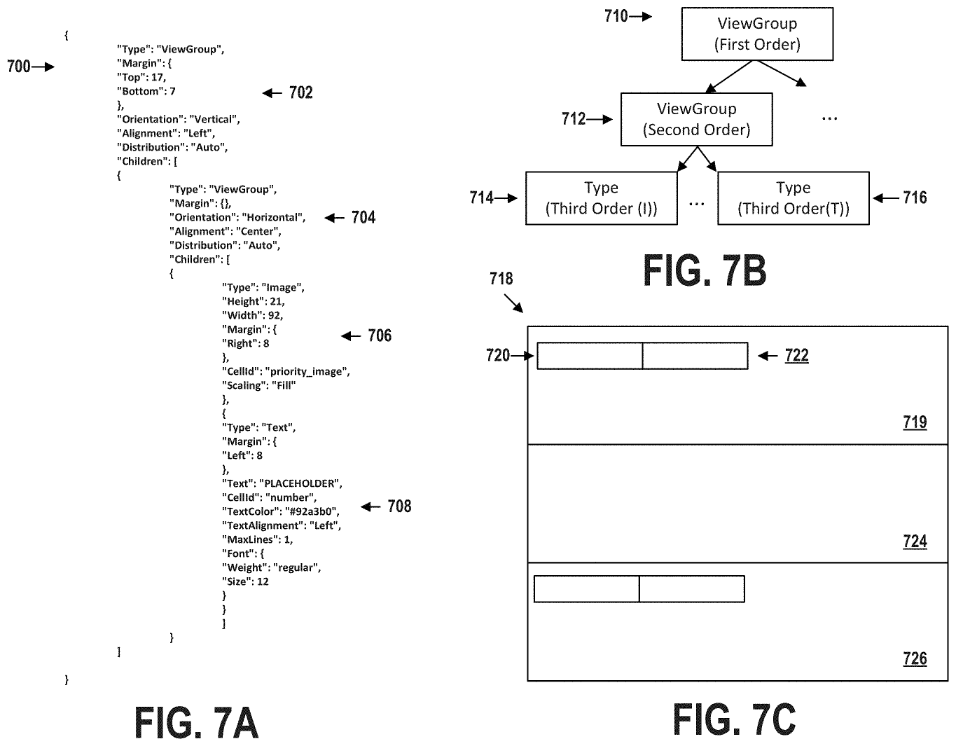

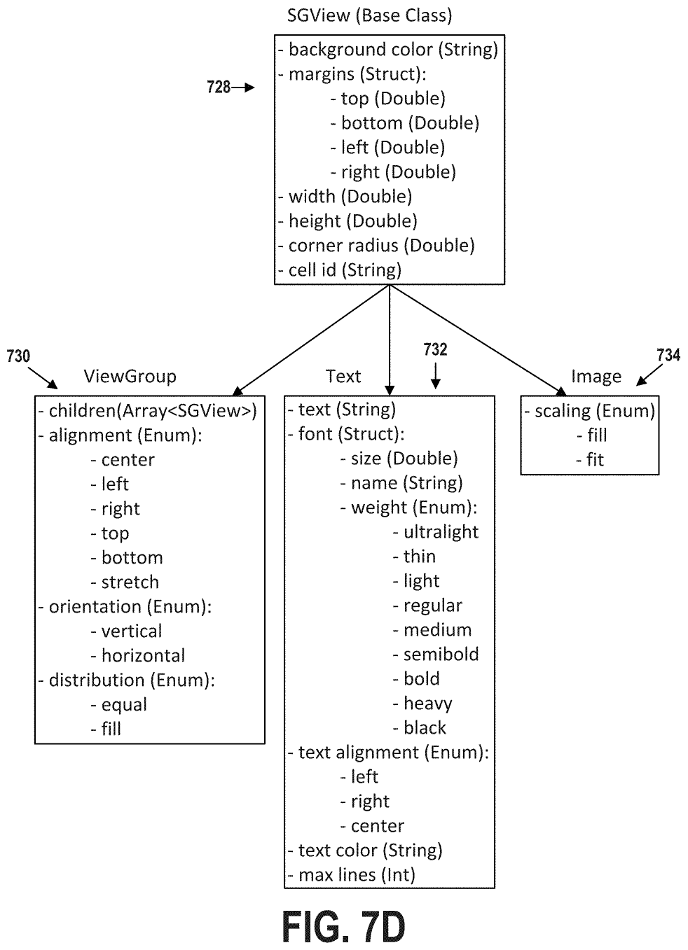

FIGS. 7A-7D provide an illustrative example of how a GUI of a native mobile application could be defined and adapted across different mobile devices. In particular, FIGS. 7A-7D provide an illustrative example of how a native mobile application can cause a GUI to be consistently displayed across different devices, regardless of the features and functionalities of those devices (e.g., orientations, platforms and operating systems, etc.). Nonetheless, the embodiments herein can operate with a wide variety of GUI layouts and designs, and should not be viewed as limited to this example.

Displaying the content of a GUI and its arrangement may be triggered by a variety of events (e.g., launching the application on the mobile device, selection of elements displayed thereon, etc.), all of which can be specified in data transmitted to a native mobile application (e.g., during step 616 of FIGS. 6A and 6B, and/or step 628 of FIG. 6B). While this data can be formatted according to various protocols, one possible formatting is in accordance with JavaScript Object Notation (JSON).

A JSON file that contains all of the information regarding the GUIs described herein could be quite large (e.g., over 1000 lines of text). For sake of simplicity, a few sections of such a JSON file are discussed below.

FIG. 7A depicts an example JSON specification 700 of a recursive, hierarchical definition of a platform-independent GUI. Notably, this example defines layout, orientation, text and image placement, text and image size, and various other text-related characteristics (e.g., color, font) for various containers displayable in native mobile application GUIs (e.g., on a mobile device). These attributes define the relative arrangement of a container of a GUI, in which other containers, text, and/or images may be placed, and the arrangement defines a relative placement of this content on the GUI. Section 702 of specification 700, for example, illustrates the highest level in an ordered hierarchy of displayed content and its arrangement. In this example, section 702 defines a first-order ViewGroup as having particular dimensions (“Margin”:{“Top”:17, “Bottom”:7}), as well as a particular orientation (“Vertical”), alignment (“Left”), and distribution (“Auto”).

Herein, a “ViewGroup” may represent a container. Each container may encompass one or more other containers, image boxes, or text boxes. Thus, the JSON content of specification 700 defines a hierarchical, tree-like structure of GUI elements.

Turning to section 704 of specification 700, a second-order ViewGroup is illustrated, showing the displayed content and its arrangement within the first-order ViewGroup. In this example, section 704 defines a ViewGroup as having a particular orientation (“Horizontal”), alignment (“Center”), and distribution (“Auto”).

Turning to sections 706 and 708 of specification 700, third-order types of data are illustrated showing the displayed content and its arrangement within the second-order ViewGroup. In this example, section 706 defines an image “Type” as having particular dimensions (“Height”: 21, “Width”: 92, “Margin”:{“Right”: 8}), as well as string to point to a specific piece of data to be presented in this subpart (an image, shown here as “CellId”:“priority_image”). Additionally, section 708 defines a text “Type” as having particular dimensions (“Margin”:{“Left”: 8}), a string to point to a specific piece of data to be presented in this subpart (text, shown here as “CellId”:“number”), and formatting for how to present that data, including color (“TextColor”: “#92a3b0”), alignment (“TextAlignment”: “Left”), how many lines or rows it should take up in the container (“MaxLines”: 1) and font (“Font”:{“Weight”: “regular”, “Size”: 12}). Other characteristics are possible as well.

The JSON-based GUI definition of FIG. 7A may be arbitrarily large or small, may be displayed in any number of orientations, and may contain any number of containers in any recursive nesting arrangement. In some embodiments, the JSON file may also define the content that is to be displayed in these containers (e.g., text, URLs referring to images, etc.) or refer to content to be obtained from specific fields of a database table. Alternatively, this content can be defined in a separate file. Regardless of where it is located, the content may be linked to the GUI definition by the “CellId” attributes. For example, GUI definition of FIG. 7A may define a number of containers, each with a unique CellId, and the content may refer to these CellIds in order to map content values (e.g., text, URLs referring to images, etc.) to containers.

FIG. 7B depicts a tree-like hierarchical view of the sections of specification 700 as described in connection with FIG. 7A. As shown, FIG. 7B illustrates first-order ViewGroup 710 (pertaining to a high-level layout and orientation of content to be displayed on a mobile device and corresponding to section 702), second-order ViewGroup 712 (pertaining to the displayed content and its arrangement within the first-order ViewGroup 710 and corresponding to section 704), and two third-order types of data (pertaining to image-based content and text-based content to be displayed in a row of second-order ViewGroup 712). Particularly, type 714 is an image box (I) and corresponds to section 706, while type 716 is a text box (T) and corresponds to section 708. As noted by the “ . . . ” in FIG. 7B, other content, ViewGroup[s], types, and associated characteristics are possible in connection with FIGS. 7A and 7B.

FIG. 7B demonstrates that the recursive, hierarchical GUI definition of FIG. 7A can be represented as a tree in which ViewGroup containers are root or intermediate nodes and Type containers (e.g., images boxes and text boxes) are leaf nodes. As with the JSON definition of FIG. 7A, the tree of FIG. 7B can be arbitrarily complex and arbitrarily deep.

As seen in FIG. 7C, the JSON file excerpt in FIG. 7A can be used on various platforms to create a GUI layout in accordance with the definition therein. For example, when processed, section 702 of specification 700, might cause a container 718 to be defined as having a particular orientation (here, vertical), alignment (here, left), and distribution of some content therein (here, e.g., auto), and to be displayed on a GUI of a native mobile application executing on a mobile device. As illustrated in FIGS. 7A and 7B, container 718 corresponds to section 702 and ViewGroup 710.

Container 718 may include containers 719, 724, and 726 (e.g., sub-containers of container 718), each of which may also contain further nested containers. Container 719 is defined by section 704 and ViewGroup 712. Here, the definitions of containers 724 and 726 are omitted from the JSON file of FIG. 7A. The vertical orientation of container 718 causes containers 719, 724, and 726 to be arranged, overall, vertically; but, the definitions of containers 719, 724, and 726 cause them, individually, to be arranged horizontally (corresponding to section 704, e.g., for container 719).

Specifically, container 719 contains GUI elements 720 and 722. GUI element 720 is defined by section 706 and type 714, and GUI element 722 is defined by section 708 and type 716. The horizontal orientation of container 719 causes containers 720 and 722 to be arranged horizontally. Note that container 724 is depicted as not containing any sub-containers or boxes, while container 726 is depicts as containing two sub-containers or boxes, similar to those of container 719.

There is a direct and unambiguously-defined relationship between the GUI definition of FIG. 7A, the tree-based view thereof in FIG. 7B, and the arrangement of containers in the GUI actually being displayed in FIG. 7C. This allows a GUI to be defined programmatically, and this definition can be dynamically generated and delivered upon request to a native mobile application.

FIG. 7D defines a class hierarchy for elements of the GUI definition described in the context of FIGS. 7A, 7B, and 7C. This hierarchy defines a recursive data structure for representing such a GUI definition.

In FIG. 7D, for example, a base class 728 can be defined (e.g., “SGView (Base Class)”). Within this base class, one or more characteristics might also be defined, including: color (e.g., “background color (String)”), margins (e.g., “margins (Struct):”, “top (Double)”, “bottom (Double)”, “left (Double)”, “right (Double)”), dimensions (“width (Double)”, “height (Double)”) and presentation (“corner radius (Double)”), and code to point to a specific piece of data to be presented in this subpart (“cell id (String)”, discussed above in terms of “CellId”).

Base class 728 supports subclasses 730, 732, and 734. The native mobile application may use one or more of these subclasses to map content, both in terms of what is presented (e.g., text and images) and how it is presented (e.g., layout) via the GUI. Subclass 730 defines a ViewGroup as described above. Particularly, Subclass 730 specifies one or more characteristics including children to be nested within a container defined by a ViewGroup (e.g., “children(Array<SGView>)”), alignment (e.g., “alignment (Enum)”, “center”, “left”, “right”, “top”, “bottom”, and “stretch”), orientation (e.g., “orientation (Enum)”, “vertical”, and “horizontal”), and distribution (“distribution (Enum)”, “equal”, and “fill”).

Subclass 732 defines the data type Text, data including text to be presented within a ViewGroup (e.g., “text (String)”), font (e.g., “font (String)”, “size (Double)”, “name (String)”, and “weight (Enum)”, which may be further defined as “ultralight”, “thin”, “light”, “regular”, “medium”, “semibold”, “bold”, “heavy”, and “black”), and text alignment (e.g., “text alignment (Enum)”, “left”, “right”, and “center”), as well as color (“text color (String)”), and how many lines/rows the text should take up in the container (“max line (Int). Subclass 734 defines the data type Image, including how an image box should be scaled within a container may also be defined (e.g., “scaling (Enum)”, “fill” and “fit”).

In accordance with object-oriented design, base class 728 may represent the base view with all the base properties of a particular GUI layout appearing on the native mobile application, while (1) subclass 730 may inherit from base class 728, allowing the native mobile application to arrange subparts in a vertical or horizontal layout, (2) subclass 732 may inherit from base class 728, allowing the native mobile application to display text; and (3) subclass 734 may inherit from base class 728, allowing the native mobile application to display one or more images.

All of these definitions are in accordance with a recursively-defined, container-based, spatially-organized arrangement of the content. Other characteristics, layouts, and hierarchies are possible.

In some embodiments, the representation of the tree (e.g., a JSON string or file) is stored in-memory as a tree (using JavaScript classes). Each therein node stores a respective GUI element and its properties. As noted previously, such a GUI element can be either a container, text box or image box, with the only restrictions being that the root node and intermediate nodes are containers, and the leaf nodes are not containers. When displayed on a web-based GUI, the in-memory tree is traversed and rendered using React components. When saved the tree is traversed and compiled into the aforementioned JSON string or file.

C. Example GUIs Based on Received Content

To make the GUIs described herein more concrete, examples thereof depict information related to IT incidents, pursuant to the encoding of content and the arrangements, as shown in FIGS. 7A-D, above.

These incidents may be opened by technology users of an enterprise who are having difficulties with hardware or software services. Each incident may include fields defining: the priority of the incident, a unique number or code assigned to the incident, a brief description of the problem that the user experienced, the state of the incident (e.g., new, being assessed, in progress, resolved, closed), and the time at which the incident was opened, among other fields (e.g., the location of the user, the category of problem (e.g., hardware or software), to whom the incident is assigned, the identity of the user (or caller) who opened the incident, etc.).

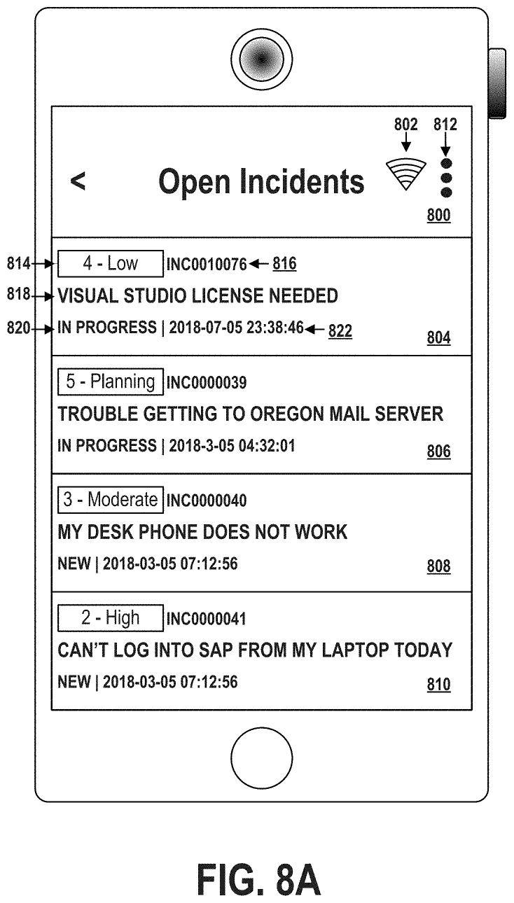

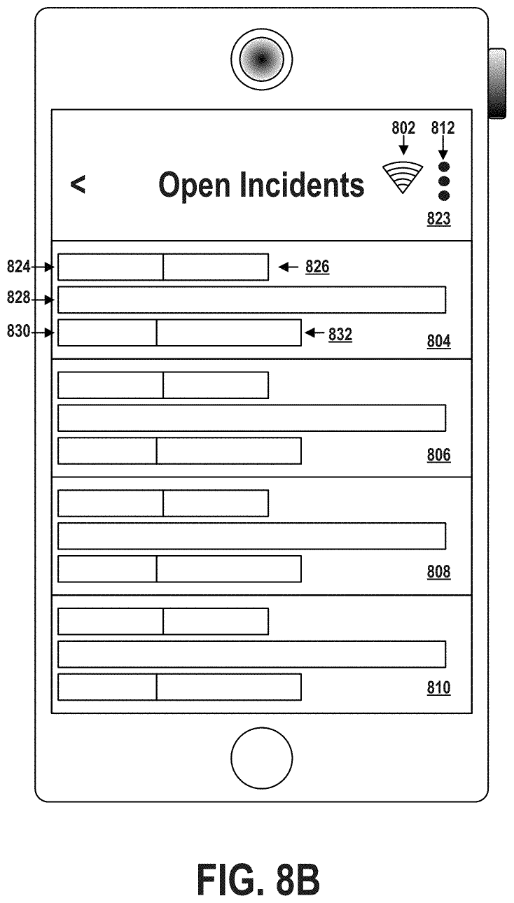

FIG. 8A depicts a GUI of a mobile device displaying a list of open incidents. The content of this GUI contains information related to the incidents, including the priorities of the incidents, incident numbers, brief descriptions, incident states, and the times at which the incidents were opened.

The arrangement of this content is a single column of containers, each containing information related to a particular incident. Other arrangements may be used instead. For example, these arrangements may include multiple columns and/or rows of containers, such as an m×n grid of containers. Within each container, each unit of text or graphical icon can be individually assigned a location. For instance, in container 800, the text “Open Incidents” is vertically and horizontally centered, while the wireless connectivity icon 802 is placed in the upper right corner.

Furthermore, font and color schemes may be defined individually for a container or for a group of containers. These schemes may set forth the size, style, and color of the text in the containers, the background color of the containers, and various other properties such as what a container looks like when it is selected and so on.

One or more containers and one or more characteristics of those containers may be displayed by a native mobile application. For example, pursuant to instructions stored locally, from a server device, or both, a GUI of a mobile device may display container 800 containing the text “Open Incidents,” which is also displayed vertically and horizontally centered, and with the wireless connectivity icon 802 and icon 812 placed in the upper right corner. Icon 812 may be a selectable drop-down menu containing ways to change the information related to the tickets or to navigate to other menus, among other possibilities.

In a further aspect, the native mobile application may display user interface elements to provide a layout to convey information pertaining to the different incidents. For example, containers 804, 806, 808, and 810 may be displayed to convey information related to respective single incidents.

As discussed above, the information displayed in containers 804, 806, 808, and 810 may include incident priorities, incident numbers, brief descriptions, incident states, and the times at which the incidents were opened. The information that is ultimately displayed in these containers may be obtained and displayed in a number of ways.

The native mobile application may request and receive more information than is displayed. For example, FIG. 8A only displays information related to four incidents, but the JSON file may have included information related to more than four incidents. Thus, turning back to FIG. 6A for a moment, the native mobile application may request and receive some or all information related to a number of incidents at steps 610-616. In response to receiving the data, native mobile application 602 may display the content that fits on the GUI in accordance with an arrangement. This allows native mobile application 602 to adapt to varying mobile device screen sizes (e.g., a smartphone with a 6 inch screen versus a tablet with a 10 inch screen).

For example, this data may include content for display on the GUI, a defined arrangement of this content, and instructions for mapping the content. In some embodiments, the content may be formatted and arranged using JSON in accordance with FIG. 7A. Thus, native mobile application 602 may display the content on the GUI in accordance with the arrangement defined by the received JSON, for example as shown in FIG. 7C. This content may be recursively defined and displayed as recursively-nested sets of vertical or horizontal containers encompassing further containers, image boxes, and text boxes, where the content is mapped to the containers pursuant to the JSON definition (e.g., with identifiers mapping units of the content to containers pursuant to a particular arrangement).

As shown in FIG. 8A, the information displayed in container 804 is shown as incident priority 814, incident number 816, brief description 818, incident state 820, and the time at which the incident was opened 822. The native mobile application may display this information based a definition of container 804 that the native mobile application interprets as particular arrangement of the information.

The information used to populate the image box and text box GUI elements may be obtained from specific fields of one or more database tables. For example, the content of brief description 818 (“Visual Studio License Needed”) may be obtained from a “brief description” field of an “incidents” database table. The database tables may be stored in a database (e.g., database 608), and queried by a server device (e.g., server device 606) that provides the structured data (e.g., JSON formatted data) to the native mobile application (e.g., native mobile application 602) of the mobile device (e.g., mobile device 600).

Container 804 of FIG. 8B includes five text boxes that allow the presentation of information related to a single incident. Particularly, as shown in FIG. 8B, text box 824 corresponds to incident priority 814, text box 826 corresponds to incident number 816, text box 828 corresponds to brief description 818, text box 830 corresponds to incident state 820, and text box 832 corresponds to the time at which the incident was opened. Thus, for example, the JSON file of FIG. 7A may also include definitions (not shown) for the arrangement of all three rows of text boxes (the top row containing text boxes 824 and 826, the middle row containing text box 828, and the bottom row containing text boxes 830 and 832). Further, the JSON file may also define the horizontal arrangement of text boxes 824 and 826 within the first row, the horizontal arrangement of text box 828 within the second row, and the horizontal arrangement of text boxes 830 and 832 within the third row.

More or less information may appear in each container and text box, and different arrangements may be used. Advantageously, the definitions in the JSON file allow a cross-platform layout to be defined that can be consistent (though not necessarily exact) across multiple types of mobile devices.

In one example, the JSON file may contain content in particular arrangement (e.g., containers displaying the text “Open Incidents,” a wireless connectivity icon 802, and containers 804, 806, 808, and 810 pertaining to individual incidents). Then, native mobile application may map this content to produce: (1) a GUI layout in accordance with an arrangement (e.g., creating and arranging containers and sub-containers in one or more vertical and/or horizontal stacks); and (2) the content to be displayed within that arrangement (e.g., text and images to be displayed in the containers and sub-containers).

In one example, this may be accomplished by the native mobile application defining a layout of one or more rows in a table-like view and populating data into these rows by mapping specific pieces of data to each row and/or the sub-containers within. As illustrated in FIG. 8B, the native mobile application may display particular GUI elements (e.g., container 804 and the elements therein) to which it maps data. The native mobile application may do so by creating and arranging text boxes 824, 826, 828, 830, and 832, and inserting text and image content displayed as items 814, 816, 818, 280, and 822 into those text boxes, respectively, and according the defined arrangement. And, this all may be accomplished whether the data, information, and content is retrieved from local storage or from another device (e.g., a server device).

### VI. GUI ELEMENT TEMPLATES FOR DEFINING A NATIVE MOBILE APPLICATION INTERFACE

As noted previously, the embodiments herein provide improvements to the design of GUIs for native mobile applications at least in part through the use of GUI element templates. These GUI element templates define a container and its contents (which may be further containers, image boxes, and/or text boxes arranged in a particular fashion). Each container defined in this fashion may specify some or all of a native mobile application GUI. Advantageously, several GUI element templates may be pre-defined, and may further be selectable by an enterprise administrator to serve as the basis of designing a new or improved GUI for a native mobile application. Doing so gives the administrator a head start in the design process and eliminates the need for coming up with a layout for at least part of this GUI.

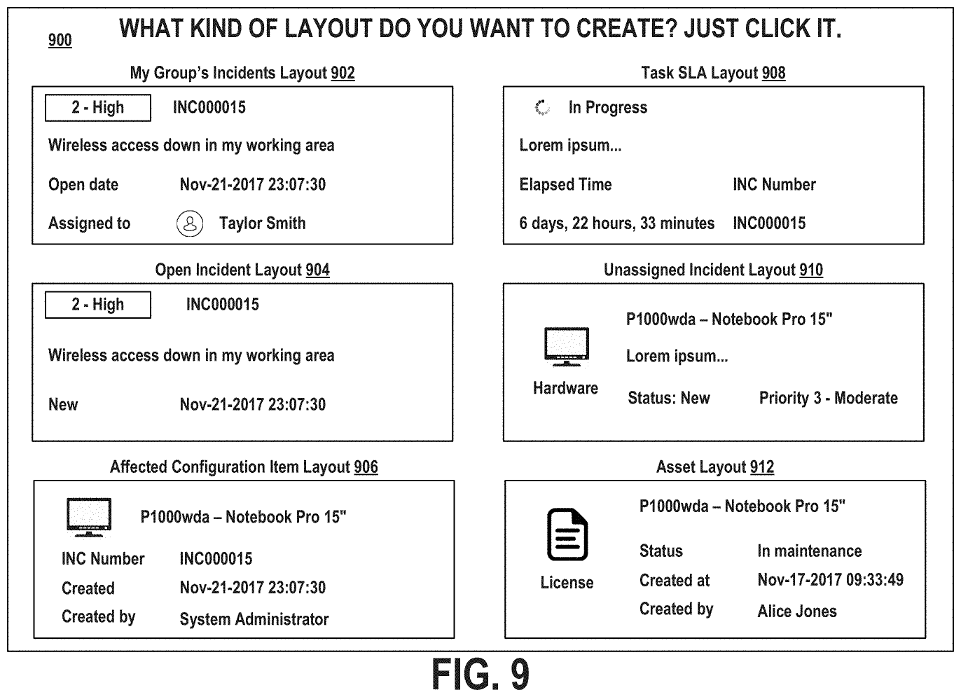

FIG. 9 depicts web-based GUI 900 displaying six selectable GUI element templates 902, 904, 906, 908, 910, and 912. Text at the top of web-based GUI 900 prompts the administrator to select one of the GUI element templates as the basis of a layout that the administrator can refine. Web-based GUI 900 may be provided by a remote network management platform server device to a client device associated with a managed network, and may be represented for example as JAVA® code, JavaScript code, and/or data. The client device may use the code and data to render web-based GUI 900. Thus, web-based GUI 900 (and the other web-based GUIs herein) should not be confused with the GUI of the native mobile application—particularly, the web-based GUIs are used to design the native mobile application GUI. In some cases, GUIs that are not web-based may be used for the design of the native mobile application GUI.

GUI element templates 902, 904, 906, 908, 910, and 912 are designed to represent common use cases and layouts that may be reused or modified. Each of these templates defines a single entry or block displayed in on a native mobile interface, and several such entries or blocks may be displayed on the corresponding native mobile application GUI in accordance with the layout of the selected template. In some embodiments, additional GUI element templates may be added or defined by the administrator or another user. For example, an interface may be present that allows defining and saving a new GUI element template that can then be added to the templates displayed on web-based GUI 900.

GUI element template 902 represents a group's incidents layout, where the incident's severity, number, short description, date opened, and assignee are displayed for each incident. GUI element template 904 represents an open incident layout, where the incident's severity, number, short description, and date opened are displayed for each incident. GUI element template 906 represents an affected configuration item layout, where the configuration item's name, a related incident number, date opened, and creator are displayed for each configuration item. GUI element template 908 represents a task service level agreement (SLA) layout, where the task's progress, state, description, elapsed time, and related incident number are displayed for each task. GUI element template 910 represents an unassigned incident layout, where the incident's related configuration item, brief description, status and priority are displayed for each incident. GUI element template 912 represents an asset layout, where the asset's related configuration item, status, date opened, and creator are displayed for each incident.

While GUI element templates 902, 904, 906, 908, 910, and 912 are shown including example data in their image box and text box elements, this data is populated to illustrate the respective layouts of each template. Thus, the administrator may select the layout that matches or most closely matches the desired GUI layout of the native mobile application being developed. Once one of GUI element templates is selected, it is shown in an editable interface so that it can be tailored to the meet the needs of this application.

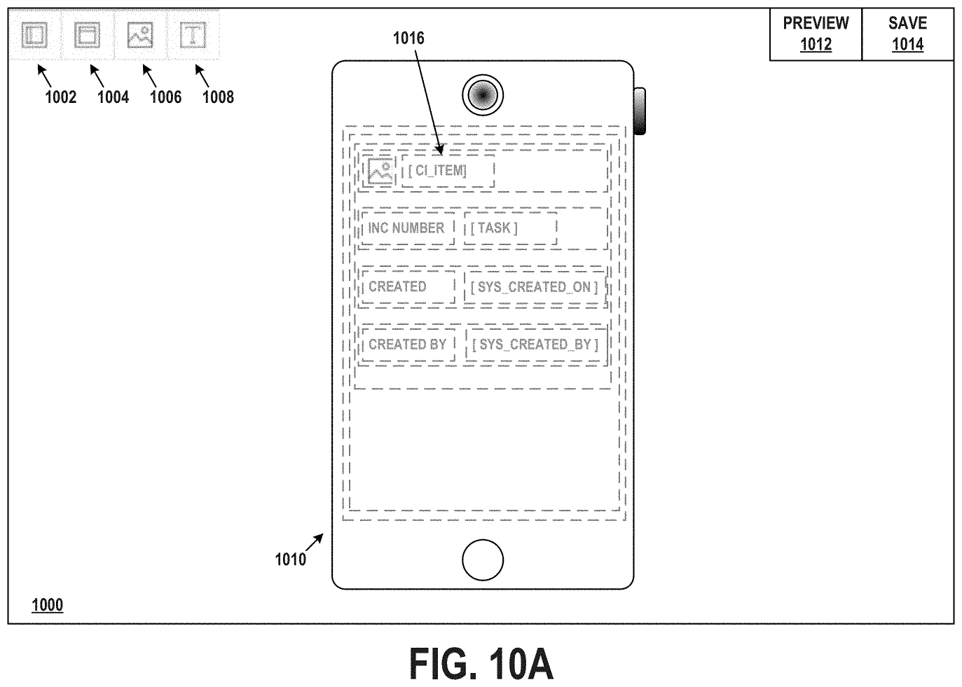

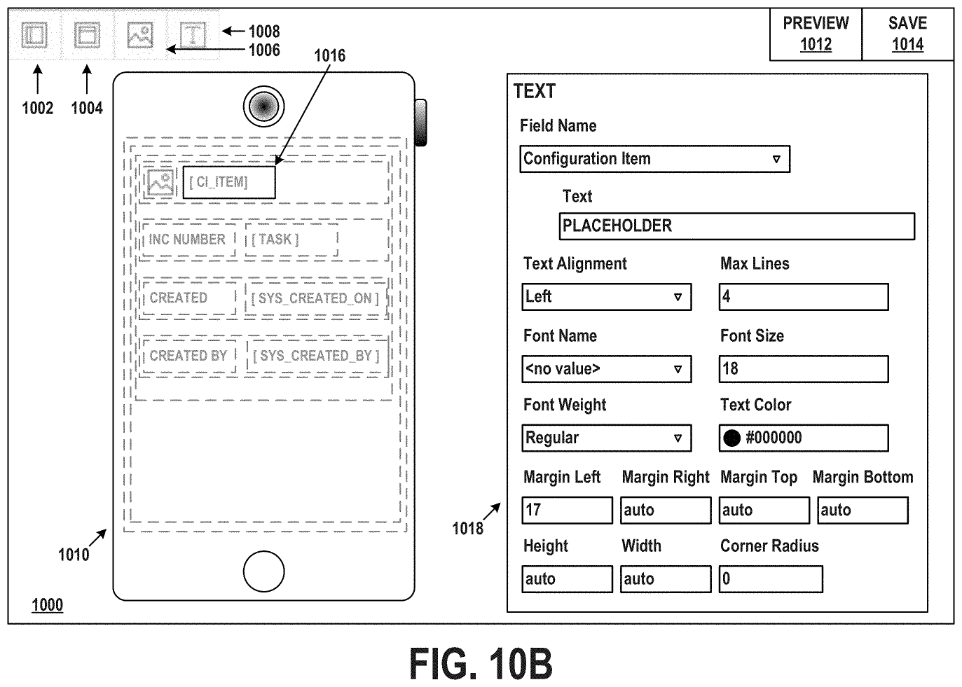

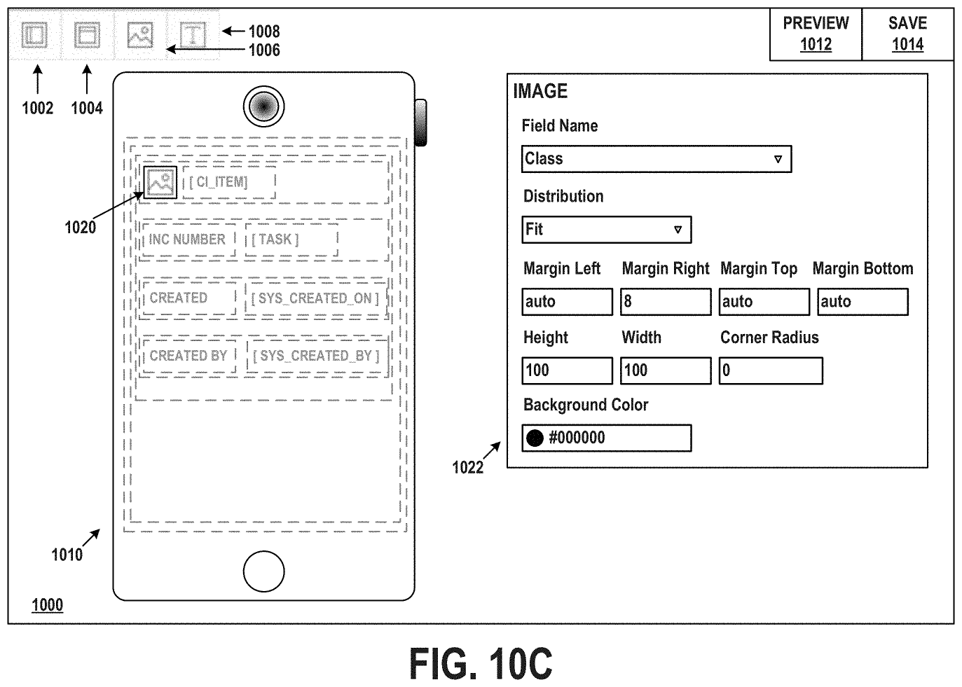

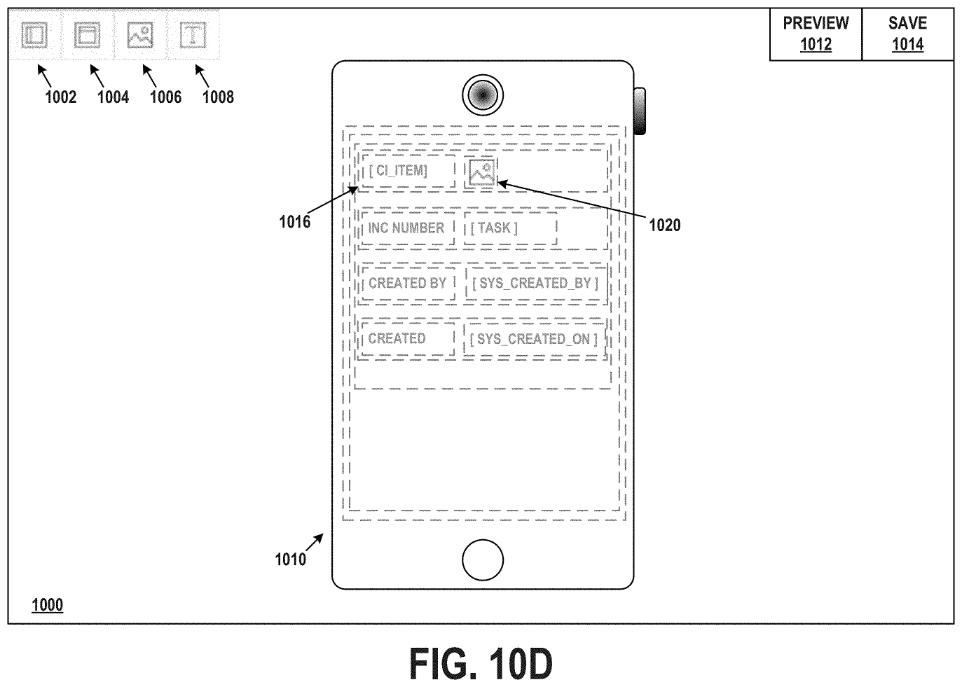

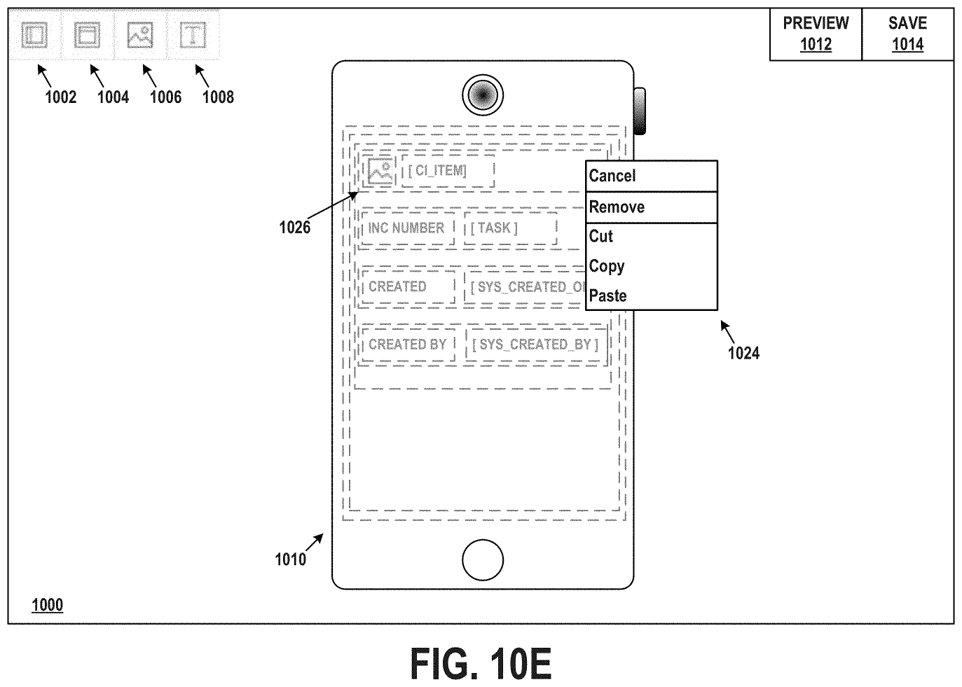

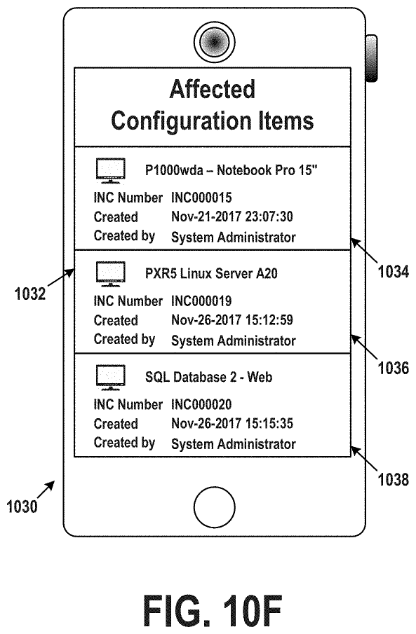

FIG. 10A shows such a web-based GUI 1000, which assumes that GUI element template 906 (affected configuration item layout) was selected. Web-based GUI 1000 includes draggable content icons 1002, 1004, 1006, and, 1008, an emulation 1010 of the layout of GUI element template 906, preview button 1012, and save button 1014. Like web-based GUI 900, web-based GUI 1000 may be provided by a remote network management platform server device to a client device associated with a managed network, and may be represented for example as JAVA® code, JavaScript code, and/or data. The client device may use the code and data to render web-based GUI 1000.

Draggable content icons 1002, 1004, 1006, and, 1008 include vertical container icon 1002, horizontal container icon 1004, image box icon 1006, and text box icon 1008. Dragging and dropping any of content icons 1002, 1004, 1006, or 1008 onto emulation 1010 results in the content icon being inserted into the layout where it is dropped. For example, if image box icon 1006 is dragged and dropped to the right of text box 1016, a new image icon would be placed in the rightmost position of the horizontal container that includes text box 1016. This facilitates rapid design and development of interfaces for a native mobile application by leveraging (and possibly adapting) the arrangement of the GUI element template.

Emulation 1010 contains a layout representing the hierarchy of the selected GUI element template. Each of the horizontal containers, vertical containers, image boxes and text boxes are selectable, can be configured, and also can be dragged and dropped to other locations in emulation 1010. Notably, these GUI elements may be displayed in a different color or shade to indicate that they are unselected. This color or shade may change when they are selected.

Further, entries in a GUI element that begin and end with brackets may specify a field within a database table from which data is obtained to populate the GUI element. For example, text box 1016 specifies [ci_item], which may be a field in a configuration item database table that is used to populate text box 1016. The other text boxes referencing such database table fields ([task], [sys_created_on], and [sys_created_by]) may be populated in a similar fashion.

Preview button 1012 may be actuatable (e.g., selectable or clickable by a pointing device, keyboard, human appendage, stylus, etc.) to cause a preview of the native mobile application GUI to be displayed. This preview may display the GUI elements in the specified hierarchy. Further, the preview may be populated by data obtained from one or more database tables of the remote network management platform. For purposes of the preview, the first 5, 10, 20, etc. rows of data from the referenced database tables may be used to populate the specified fields. Alternatively, a random 5, 10, 20, etc. rows of data from the referenced database tables may be used to populate these fields. This allows the administrator to obtain a viewable presentation of how the native mobile application GUI will appear on a mobile device without having to deploy the native mobile application to an actual mobile device.

Save button 1014 may be actuatable to save a representation of the native mobile GUI layout and content to persistent storage (e.g., disk or other non-volatile memory) within the remote network management platform. As noted above, the data saved may be in the form of a JSON string or file in line with the example of FIG. 7A. The exact content of the JSON file will vary between GUI layouts. The resulting JSON can be deployed to mobile devices in order to cause any native mobile applications thereon to display a GUI as defined by the JSON content.

Though not shown, web-based GUI 1000 may also include a magnifying glass and/or slider icon or element that allows the user to zoom in or zoom out of the view provided by web-based GUI 1000. In conjunction with the drag and drop features described below, this allows the user to accurately place and arrange GUI elements within emulation 1010.

Further, each of these GUI elements may be actuatable for purposes of configuration. For example, actuating any GUI element (e.g., any horizontal container, vertical container, image box or text box) may cause a configuration pane to appear. The configuration pane may facilitate setting the margins, height, width, and possibly other aspects of the GUI element, for example. Additionally, specific types of GUI elements may be further configured.

As shown in FIG. 10B for example, actuating text box 1016 (e.g., selecting it using a left mouse button) may cause configuration pane 1018 to appear. In various embodiments, pane configuration pane 1018 may be displayed in different locations of web-based GUI 1000 rather than the location shown.

Configuration pane 1018 allows the administrator to change the properties of text box 1016. Starting from the top of configuration pane 1018, GUI controls allow specifying the database table field used to populate text box 1016 (shown as “Configuration Item”) from a drop-down menu, and specifying default text if no field is selected (shown as “PLACEHOLDER”).

Further controls allow specifying the alignment of text within text box 1016 (shown as “Left”) from a drop-down menu (other values might be “Center” and “Right”), the maximum number of vertical lines in text box 1016 (shown as “4”), the font of the text in text box 1016 (shown as “<no value>”) from a drop-down menu, the font size of the text in text box 1016 (shown as “18”), the weight of text in text box 1016 (shown as “Regular”) from a drop-down menu (other values might be “Heavy” and “Light”), and color of text in text box 1016 (shown as “#000000” with a black circle to its left to indicate that the selected text color is black).

Additional controls allow specifying left, right, top and bottom margins of text box 1016 (as shown, the left margin is 17 units, and the other margins are configured to be automatically set), the height and width of text box 1016 (as shown, both are configured to be automatically set but can be specified in units of rows, columns, pixels, etc.), and the corner radius of text box 1016 (which defines the amount of rounding of the corners of text box 1016, and is shown as 0).

In general, any of the options for text boxes shown in FIG. 7D (e.g., base class 728 and subclass 732) may be configurable by way of configuration pane 1018.

In another example, FIG. 10C depicts actuating image box 1020 (e.g., selecting it using a left mouse button) to cause configuration pane 1022 to appear. In various embodiments, configuration pane 1022 may be shown in different locations of web-based GUI 1000 rather than the location shown.

Configuration pane 1022 allows the administrator to change the properties of image box 1020. Starting from the top of configuration pane 1022, GUI controls allow specifying the database table field used to populate image box 1020 with an image (shown as “Class”) from a drop-down menu, and specifying the distribution of the image into image box 1020 (shown as “fit” to indicate that the image should be sized to fit in the image box).

Further controls allow specifying left, right, top and bottom margins of image box 1020 (as shown, the right margin is 8 units, and the other margins are configured to be automatically set), the height and width of image box 1020 (as shown, both are configured to be 100 pixels, but can be specified in other units of rows, columns, etc.), the corner radius of image box 1020 (shown as 0), and the background color of image box 1020.

In general, any of the options for text boxes shown in FIG. 7D (e.g., base class 728 and subclass 734) may be configurable by way of configuration pane 1018.

Any changes to the configuration of a GUI element may be represented in a structured data format (e.g., JSON or XML) which is then stored automatically or upon actuation of save button 1014.

Not unlike draggable content icons 1002, 1004, 1006, and, 1008, the GUI elements displayed in emulation 1010 may be dragged and dropped (e.g., with a mouse or other pointing device) to modify the native mobile application GUI. For instance, FIG. 10D shows the result of either dragging and dropping text box 1016 to the left of image box 1020 or dragging and dropping image box 1020 to the right of text box 1016. In general, any GUI element can be dragged and dropped into a horizontal or vertical container, or arranged as desired within such a container.

Furthermore, actuating a GUI element in a different fashion than is used to drag and drop such elements (e.g., with a right mouse button rather than a left mouse button) may cause web-based GUI 1000 to display an editing menu. For example, in FIG. 10E, editing menu 1024 is shown for container 1026. Container 1026 holds text box 1016 and image box 1020. Editing menu 1024 provides selectable options for removing container 1026, copying container 1026 to a buffer, cutting container 1026 (e.g., copying container 1026 to a buffer then removing container 1026), pasting the contents of the buffer into container 1026, or cancelling (e.g., exiting editing menu 1024). Other possibilities exist.

As noted above, once an administrator (or other person or entity) is satisfied with the definition of a native mobile application GUI as shown in web-based GUI 1000, save button 1014 can be used to generate or update a JSON or XML string or file representing the native mobile application GUI. This structured data may then be deployed as needed (e.g., upon request or automatically) to a mobile device.

FIG. 10F depicts a mobile device 1030 displaying native mobile interface 1032. Native mobile interface 1032 may have been configured by way of web-based GUI 1000. As shown in FIGS. 9-10E, the affected configuration item template was selected but this template was not modified. Accordingly, native mobile interface 1032 contains instances 1034, 1036, and 1038 of the GUI element template populated with data from one or more database tables. These tables may be stored in an incident database, a CMDB, and/or a separate database.

Advantageously, the embodiments herein allow an administrator to rapidly prototype and develop native mobile interface 1032 in an interactive fashion. This eliminates having to manually configure GUI elements and instead allows the administrator to select a GUI element template that matches or is close to matching his or her desired layout. Further, the embodiments herein avoid having to deploy numerous versions of native mobile interface 1032 to an actual mobile device only to find out that the layout is not what was expected. Instead, the layout can be fully designed and debugged using a web-based GUI and an emulation of native mobile interface 1032.

### VII. EXAMPLE OPERATIONS

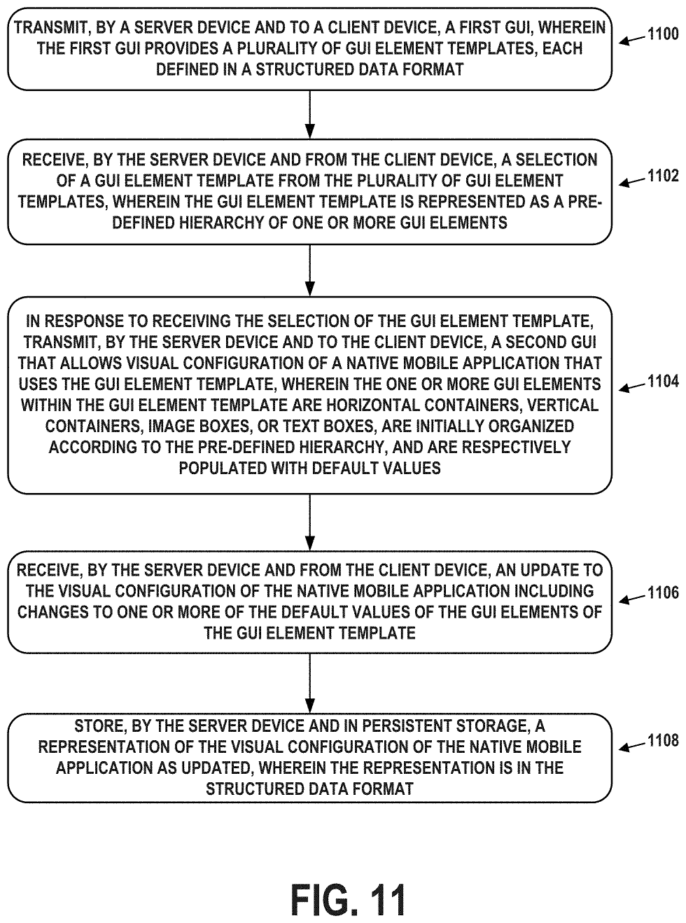

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve transmitting, by a server device and to a client device, a first GUI, wherein the first GUI provides a plurality of GUI element templates, each defined in a structured data format. The first GUI may be web-based.

Block 1102 may involve receiving, by the server device and from the client device, a selection of a GUI element template from the plurality of GUI element templates, where the GUI element template is represented as a pre-defined hierarchy of one or more GUI elements.

Block 1104 may involve, possibly in response to receiving the selection of the GUI element template, transmitting, by the server device and to the client device, a second GUI that allows visual configuration of a native mobile application that uses the GUI element template, where the one or more GUI elements within the GUI element template are horizontal containers, vertical containers, image boxes, or text boxes, are initially organized according to the pre-defined hierarchy, and are respectively populated with default values. The second GUI may be web-based.

Block 1106 may involve receiving, by the server device and from the client device, an update to the visual configuration of the native mobile application including changes to one or more of the default values of the GUI elements of the GUI element template.

Block 1108 may involve storing, by the server device and in persistent storage, a representation of the visual configuration of the native mobile application as updated, where the representation is in the structured data format.

In some embodiments, storing the representation of the visual configuration of the native mobile application as updated involves storing the visual configuration as a tree of the one or more GUI elements, where intermediate nodes of the tree are either the horizontal containers or the vertical containers, and where leaf nodes of the tree are either the image boxes or the text boxes.

In some embodiments, the structured data format comprises a JSON text string or an XML text string, or is stored in a JSON or XML file.

In some embodiments, the update to the visual configuration of the native mobile application also includes: (i) actuating a particular GUI element of the one or more GUI elements to move the particular GUI element to a different part of the visual configuration of the native mobile application, and (ii) updating the pre-defined hierarchy in accordance with the visual configuration of the native mobile application as updated, where storing the representation of the visual configuration of the native mobile application as updated comprises storing the pre-defined hierarchy as updated.

In some embodiments, the second GUI contains a plurality of selectable icons representing particular GUI elements, including a horizontal container icon, a vertical container icon, an image box icon, and a text box icon, where the update to the visual configuration of the native mobile application also includes: (i) actuating an icon from the plurality of selectable icons to include a particular GUI element associated with the icon in the visual configuration of the native mobile application, and (ii) updating the pre-defined hierarchy in accordance with the visual configuration of the native mobile application as updated, and where storing the representation of the visual configuration of the native mobile application as updated comprises storing the pre-defined hierarchy as updated.

In some embodiments, a particular GUI element of the one or more GUI elements is actuatable to display a menu with options to: remove the particular GUI element from the visual configuration, copy the particular GUI element from the visual configuration to a buffer, and paste content of the buffer to the particular GUI element.

In some embodiments, a particular GUI element of the one or more GUI elements is actuatable to display a menu with options to adjust height, width, and one or more margins of the particular GUI element.

In some embodiments, the particular GUI element is an image box, wherein the menu further includes options to map the particular GUI element to a field in a database table that refers to an image, and adjust how the image fits in the image box.

In some embodiments, the particular GUI element is a text box, where the menu further includes options to map the particular GUI element to a field in a database table that refers to text, adjust how the text is aligned within the text box, and adjust a font, font size, color, and weight of the text.

Some embodiments may involve transmitting, to a mobile device, the visual configuration of the native mobile application as updated, where reception of the visual configuration causes an executable instance of the native mobile application installed on the mobile device to display the visual configuration, and where the visual configuration is transmitted in the structured data format.

### VIII. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computational instance of a remote network management platform comprising:
persistent storage containing definitions of a plurality of graphical user interface (GUI) element templates, each defined in a structured data format;
one or more computing devices configured to:
transmit, to a client device, a first GUI, wherein the first GUI provides the plurality of GUI element templates;
receive, from the client device, a selection of a GUI element template from the plurality of GUI element templates, wherein the GUI element template is represented as a pre-defined hierarchy of one or more GUI elements;
in response to receiving the selection of the GUI element template, transmit, to the client device, a second GUI that allows visual configuration of a native mobile application that uses the GUI element template, wherein the one or more GUI elements within the GUI element template are horizontal containers, vertical containers, image boxes, or text boxes, are initially organized according to the pre-defined hierarchy, and are respectively populated with default values;
receive, from the client device, an update to the visual configuration of the native mobile application including changes to one or more of the default values of the GUI elements of the GUI element template; and
store, in the persistent storage and using the structured data format, a representation of the visual configuration of the native mobile application as updated.

2. The computational instance of claim 1, wherein storing the representation of the visual configuration of the native mobile application as updated comprises storing the visual configuration as a tree of the one or more GUI elements, wherein intermediate nodes of the tree are either the horizontal containers or the vertical containers, and wherein leaf nodes of the tree are either the image boxes or the text boxes.

3. The computational instance of claim 2, wherein the structured data format comprises a JavaScript Object Notation (JSON) text string or an eXtensible Markup Language (XML) text string.

4. The computational instance of claim 1,
wherein the update to the visual configuration of the native mobile application also includes: (i) actuating a particular GUI element of the one or more GUI elements to move the particular GUI element to a different part of the visual configuration of the native mobile application, and (ii) updating the pre-defined hierarchy in accordance with the visual configuration of the native mobile application as updated, and
wherein storing the representation of the visual configuration of the native mobile application as updated comprises storing the pre-defined hierarchy as updated.

5. The computational instance of claim 1,
wherein the second GUI contains a plurality of selectable icons representing particular GUI elements, including a horizontal container icon, a vertical container icon, an image box icon, and a text box icon,
wherein the update to the visual configuration of the native mobile application also includes: (i) actuating an icon from the plurality of selectable icons to include a particular GUI element associated with the icon in the visual configuration of the native mobile application, and (ii) updating the pre-defined hierarchy in accordance with the visual configuration of the native mobile application as updated, and
wherein storing the representation of the visual configuration of the native mobile application as updated comprises storing the pre-defined hierarchy as updated.

6. The computational instance of claim 1, wherein a particular GUI element of the one or more GUI elements is actuatable to display a menu with options to: remove the particular GUI element from the visual configuration, copy the particular GUI element from the visual configuration to a buffer, and paste content of the buffer to the particular GUI element.

7. The computational instance of claim 1, wherein a particular GUI element of the one or more GUI elements is actuatable to display a menu with options to adjust height, width, and one or more margins of the particular GUI element.

8. The computational instance of claim 7, wherein the particular GUI element is an image box, and wherein the menu further includes options to map the particular GUI element to a field in a database table that refers to an image, and adjust how the image fits in the image box.

9. The computational instance of claim 7, wherein the particular GUI element is a text box, and wherein the menu further includes options to map the particular GUI element to a field in a database table that refers to text, adjust how the text is aligned within the text box, and adjust a font, font size, color, and weight of the text.

10. The computational instance of claim 1, wherein the one or more computing devices are further configured to:
transmit, to a mobile device, the visual configuration of the native mobile application as updated, wherein reception of the visual configuration causes an executable instance of the native mobile application installed on the mobile device to display the visual configuration, and wherein the visual configuration is transmitted in the structured data format.

11. A computer-implemented method comprising:
transmitting, by a server device and to a client device, a first GUI, wherein the first GUI provides a plurality of GUI element templates, each defined in a structured data format;
receiving, by the server device and from the client device, a selection of a GUI element template from the plurality of GUI element templates, wherein the GUI element template is represented as a pre-defined hierarchy of one or more GUI elements;
in response to receiving the selection of the GUI element template, transmitting, by the server device and to the client device, a second GUI that allows visual configuration of a native mobile application that uses the GUI element template, wherein the one or more GUI elements within the GUI element template are horizontal containers, vertical containers, image boxes, or text boxes, are initially organized according to the pre-defined hierarchy, and are respectively populated with default values;
receiving, by the server device and from the client device, an update to the visual configuration of the native mobile application including changes to one or more of the default values of the GUI elements of the GUI element template; and
storing, by the server device and in persistent storage, a representation of the visual configuration of the native mobile application as updated, wherein the representation is in the structured data format.

12. The computer-implemented method of claim 11, wherein storing the representation of the visual configuration of the native mobile application as updated comprises storing the visual configuration as a tree of the one or more GUI elements, wherein intermediate nodes of the tree are either the horizontal containers or the vertical containers, and wherein leaf nodes of the tree are either the image boxes or the text boxes.

13. The computer-implemented method of claim 11,
wherein the update to the visual configuration of the native mobile application also includes: (i) actuating a particular GUI element of the one or more GUI elements to move the particular GUI element to a different part of the visual configuration of the native mobile application, and (ii) updating the pre-defined hierarchy in accordance with the visual configuration of the native mobile application as updated, and
wherein storing the representation of the visual configuration of the native mobile application as updated comprises storing the pre-defined hierarchy as updated.

14. The computer-implemented method of claim 11,
wherein the second GUI contains a plurality of selectable icons representing particular GUI elements, including a horizontal container icon, a vertical container icon, an image box icon, and a text box icon,
wherein the update to the visual configuration of the native mobile application also includes: (i) actuating an icon from the plurality of selectable icons to include a particular GUI element associated with the icon in the visual configuration of the native mobile application, and (ii) updating the pre-defined hierarchy in accordance with the visual configuration of the native mobile application as updated, and
wherein storing the representation of the visual configuration of the native mobile application as updated comprises storing the pre-defined hierarchy as updated.

15. The computer-implemented method of claim 11, wherein a particular GUI element of the one or more GUI elements is actuatable to display a menu with options to: remove the particular GUI element from the visual configuration, copy the particular GUI element from the visual configuration to a buffer, and paste content of the buffer to the particular GUI element.

16. The computer-implemented method of claim 11, wherein a particular GUI element of the one or more GUI elements is actuatable to display a menu with options to adjust height, width, and one or more margins of the particular GUI element.

17. The computer-implemented method of claim 16, wherein the particular GUI element is an image box, and wherein the menu further includes options to map the particular GUI element to a field in a database table that refers to an image, and adjust how the image fits in the image box.

18. The computer-implemented method of claim 16, wherein the particular GUI element is a text box, and wherein the menu further includes options to map the particular GUI element to a field in a database table that refers to text, adjust how the text is aligned within the text box, and adjust a font, font size, color, and weight of the text.

19. The computer-implemented method of claim 11, further comprising:
transmitting, to a mobile device, the visual configuration of the native mobile application as updated, wherein reception of the visual configuration causes an executable instance of the native mobile application installed on the mobile device to display the visual configuration, and wherein the visual configuration is transmitted in the structured data format.

20. An article of manufacture including a non-transitory computer-readable medium, having stored thereon program instructions that, upon execution by a computing system, cause the computing system to perform operations comprising:
transmitting, to a client device, a first GUI, wherein the first GUI provides a plurality of GUI element templates, each defined in a structured data format;
receiving, from the client device, a selection of a GUI element template from the plurality of GUI element templates, wherein the GUI element template is represented as a pre-defined hierarchy of one or more GUI elements;
in response to receiving the selection of the GUI element template, transmitting, to the client device, a second GUI that allows visual configuration of a native mobile application that uses the GUI element template, wherein the one or more GUI elements within the GUI element template are horizontal containers, vertical containers, image boxes, or text boxes, are initially organized according to the pre-defined hierarchy, and are respectively populated with default values;
receiving, from the client device, an update to the visual configuration of the native mobile application including changes to one or more of the default values of the GUI elements of the GUI element template; and
storing, in persistent storage and using the structured data format, a representation of the visual configuration of the native mobile application as updated.
